(19) United States
(12) Patent Application Publication
(10) Pub. No.: US 2009/0034069 A1
(43) Pub. Date: Feb. 5, 2009

(54) POLARIZATION CONVERSION DEVICE AND PROJECTOR USING SAME

(75) Inventor: PI-TSUNG HSU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/972,504

(22) Filed: Jan. 10, 2008

(30) Foreign Application Priority Data
Aug. 3, 2007 (CN) 200710201278.5

(51) Int. Cl. G02B 27/28

(52) U.S. Cl. 359/485

(57) ABSTRACT

A polarization conversion device for converting a non-polarized light into a single-polarized light includes a prism substrate having a first positioning surface and an opposite second positioning surface parallel to the first positioning surface. The first and second positioning surfaces are configured for coming into contact with a positioning member. The prism substrate includes a plurality of parallelogram prisms arranged between the first and second positioning surfaces, and a plurality of polarization beam splitting layers in parallel with the first and second surfaces. The polarization beam splitting layers and the parallelogram prisms are arranged in an alternate fashion. Each of the plurality polarization beam splitting layers is sandwiched between two adjacent parallelogram prisms.

### BACKGROUND

1. Field of the Invention

The present invention relates to polarization conversion systems, and particularly, to a polarization conversion device and a projector using the same.

2. Description of Related Art

Polarization conversion systems are utilized in projectors requiring polarized light for operation. The polarization conversion device (PCD) is positioned in the optical path of the light source of the projector and splits the light emitted from the light source into two orthogonal polarization states rotating one to produce a single-polarized light beam.

Generally, when aligning the incident light with a typical PCD, hazed side surfaces of the typical PCD are used for positioning to do this. However, the hazed side surfaces of the typical PCD are formed by a polishing process. Alignment of the incident light with the PCD is not always satisfactory.

What is needed, therefore, is to provide a polarization conversion device having a more accurate alignment with the incident light.

### SUMMARY

The present invention relates to a polarization conversion device for converting a non-polarized light into a single-polarized light. The polarization conversion device includes a prism substrate having a first positioning surface and an opposite second positioning surface parallel to the first positioning surface. The first and second positioning surfaces are configured for coming into contact with a positioning member. The prism substrate includes a plurality of parallelogram prisms arranged between the first and second positioning surfaces, and a plurality of polarization beam splitting layers in parallel with the first and second surfaces. The polarization beam splitting layers and the parallelogram prisms are arranged in an alternate fashion. Each of the plurality polarization beam splitting layers is sandwiched between two adjacent parallelogram prisms.

Other advantages and novel features of the present invention will become more apparent from the following detailed description of present embodiments when taken in conjunction with the accompanying drawings, in which:

### BRIEF DESCRIPTION OF THE DRAWINGS

FIG. 1 is a schematic view of a polarization conversion device in accordance with a first present embodiment;

FIG. 2 is a schematic view of a polarization conversion device in accordance with a second present embodiment;

FIG. 3 is a schematic view of a polarization conversion device in accordance with a third present embodiment;

FIG. 4 is a schematic view of a polarization conversion device in accordance with a fourth present embodiment;

FIG. 5 is an isometric view of the polarization conversion device of FIG. 4; and

FIG. 6 is a schematic view of a projecting system using the polarization conversion device of FIG. 1.

### DETAILED DESCRIPTION OF THE EMBODIMENTS

Reference will now be made to the figures to describe the present embodiments in detail.

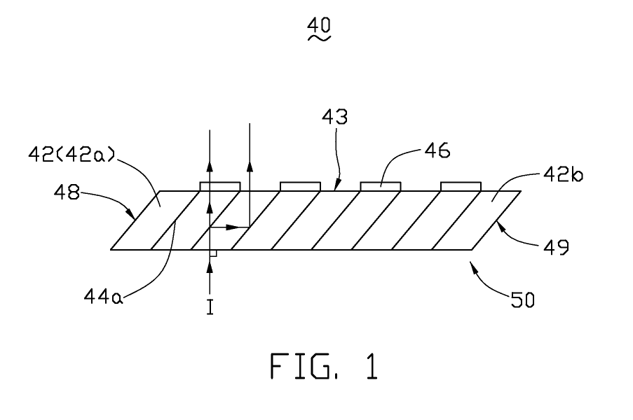

Referring to FIG. 1, a polarization conversion device 40, according to a first present embodiment, is shown. The polarization conversion device 40 (PCD) includes a prism substrate 50 having the first and second positioning surfaces 48, 49, and a plurality of parallel polarization beam splitting layers 44a (PBSLs) in parallel with the first and second positioning surfaces 48,49. The prism substrate 50 includes a plurality of parallelogram prisms 42 arranged between the first and second positioning surfaces 48, 49. The plurality of parallel PBSLs 44a and the parallelogram prisms 42 are arranged in an alternate fashion, and each of the plurality of the PBSL 44a is sandwiched between two adjacent parallelogram prisms 42.

The first positioning surface 48 and a second positioning surface 49 are formed respectively at a most-left parallelogram prism 42a and at a most-right parallelogram prism 42b of the PCD 40, as shown in FIG. 1. A plurality of spaced half-wave plates 46 (HWPs) are positioned on a surface 43 of the PCD 40, e.g., a light-emitting surface of the PCD 40. It is to be understood that the first and second positioning surfaces 48, 49 are two original parallel surfaces of the parallelogram prism 42 without coating with PBSLs 44a.

Referring to FIG. 1 again, when aligning the PCD 40 with an incident light indicated as I in FIG. 1, the first and second positioning surfaces are used for positioning the PCD 40. Since the first and second positioning surfaces 48, 49 are both parallel with the PBSL 44a, the incident light I can be satisfactorily aligned with the PBSLs 44a.

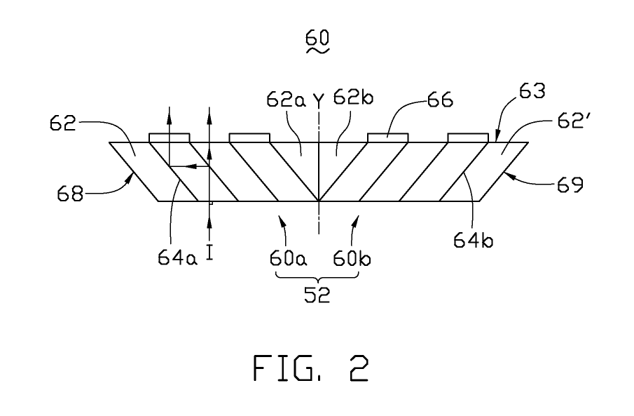

Referring to FIG. 2, a PCD 60, according to a second present embodiment, is shown. The PCD 60 includes a prism substrate 52, a plurality of parallel first PBSLs 64a and a plurality of parallel second PBSLs 64b. The prism substrate 52 includes a first sub prism substrate 60a and a second sub prism substrate 60b positioned axisymmetrically about a central axis Y of the prism substrate 52. The first sub prism substrate 60a includes a plurality of first parallelogram prisms 62, a first triangular prism 62a, and the plurality of first PBSLs 64a. The second sub prism substrate 60b includes a plurality of second parallelogram prisms 62′, a second triangular prism 62n and the plurality of second PBSLs 64b. The prism substrate 52 has a first positioning surface 68 and an opposite second positioning surface 69, and the first and second positioning surfaces 68,69 are configured for coming into contact with a positioning member (not shown). The plurality of first parallelogram prisms 62, the first triangular prism 62a, the second triangular prism 62b, and a plurality of second parallelogram prisms 62′ are arranged between the first and second positioning surfaces 68, 69.

The plurality of first PBSLs 64a are in parallel with the first positioning surface 68, and the plurality of second PBSLs 64b are in parallel with the second positioning surface 69. The first PBSLs 64a and the first parallelogram prisms 62 are arranged in an alternate fashion. Each of the plurality of first PBSLs 64a are sandwiched between two adjacent first parallelogram prism 62, except one formed between the first triangular prism 62a and the adjacent first parallelogram prism 62.

The plurality of second PBSLs 64b and the plurality of second parallelogram prism 62′ are arranged in an alternate fashion. Each of the plurality of second PBSLs 64b are sandwiched between two adjacent second parallelogram prism 62′, except one formed between the second triangular prism 62b and the adjacent second parallelogram prism 62′.

The first sub prism substrate 60a and the second sub prism substrate 60b are glued together at free sides of the first triangular prism 62a and the second triangular prism 62b to cooperatively form the PCD 60.

A plurality of spaced HWPs 66 are positioned on a light-emitting surface 63 of the PCD 40.

The first positioning surface 68 and the second positioning surface 69 are formed respectively at a most-left parallelogram prism 62 and at a most-right parallelogram prism 62′ of the PCD 60, as shown in FIG. 2. The first and second positioning surfaces 68, 69 are respectively parallel with the first and second PBSLs 64a, 64b. It is to be understood that the first and second positioning surfaces 68, 69 are two original surfaces of the first and second parallelogram prisms without coating with the PBSLs 64a, 64b.

When aligning the PCD 60 with an incident light indicated as I in FIG. 2, the first and second positioning surfaces 48, 49 are used for positioning the PCD 60. Since the first and second positioning surfaces 48, 49 are respectively parallel with the first and second PBSLs 64a, 64b and positioned axisymmetrically about a central axis Y of the prism substrate 52, the incident light I can be satisfactorily aligned with the first and second PBSLs 64a, 64b.

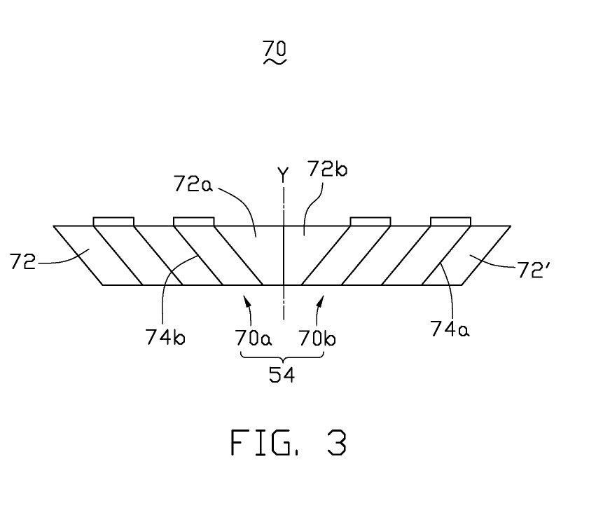

Referring to FIG. 3, a PCD 70, according to a third present embodiment, is shown. Differences between the PCD 70 of the third present embodiment and the PCD 60 of the second present embodiment are that the first sub prism substrate 70a of the prism substrate 54 includes a first trapezoid prism 72a and the second sub prism substrate 70b of the prism substrate 54 includes a second trapezoid prism 72b. The first and second trapezoid prisms 72a, 72b are positioned axisymmetrically about a central axis Y of the prism substrate 54, and glued together.

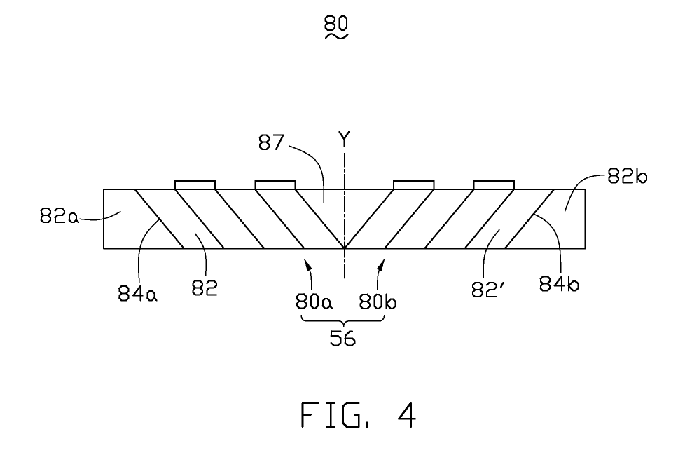

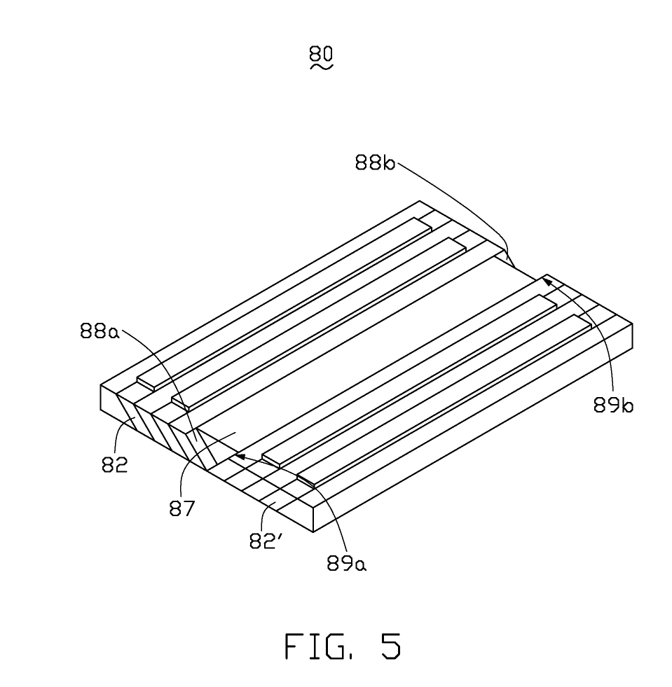

Referring to FIGS. 4 and 5, a PCD 80, according to a fourth present embodiment, is shown. Differences between the PCD 80 of the fourth present embodiment and the PCD 60 of the second embodiment are that the PCD 80 includes a triangular prism 87, and the first sub prism substrate 80a of the prism substrate 56 includes a first trapezoid prism 82a, and the second sub prism substrate 80b of the prism substrate 56 includes a second trapezoid prism 82b.

Each of the plurality of first PBSLs 84a are sandwiched between two adjacent first parallelogram prism 82, except one formed between the first trapezoid prism 82a and the adjacent first parallelogram prism 82. Each of the plurality of second PBSLs 84b are sandwiched between two adjacent second parallelogram prism 82′, except one formed between the second trapezoid prism 82b and the adjacent second parallelogram prism 82′.

The first and second trapezoid prisms 82a, 82b are positioned respectively at the most-left side and most-right side of the prism substrate 56, as shown in FIG. 4. The triangular prism 87 is positioned between the first sub prism substrate 80a and the second sub prism substrate 80b, and the first sub prism substrate 80a and the second sub prism substrate 80b are positioned axisymmetrically about a central axis Y of the prism substrate 56. A length of the triangular prism 87 is shorter than that of the first or second sub prism substrates 80a, 80b. Therefore, first positioning surfaces 88a, 88b, and second positioning surfaces 89a, 89b are formed correspondingly, as shown in FIG. 5. It is to be understood that the first trapezoid prism 82a and the second trapezoid prism 82b may be omitted.

Advantages of the third and fourth present embodiment are similar to those of the second present embodiment.

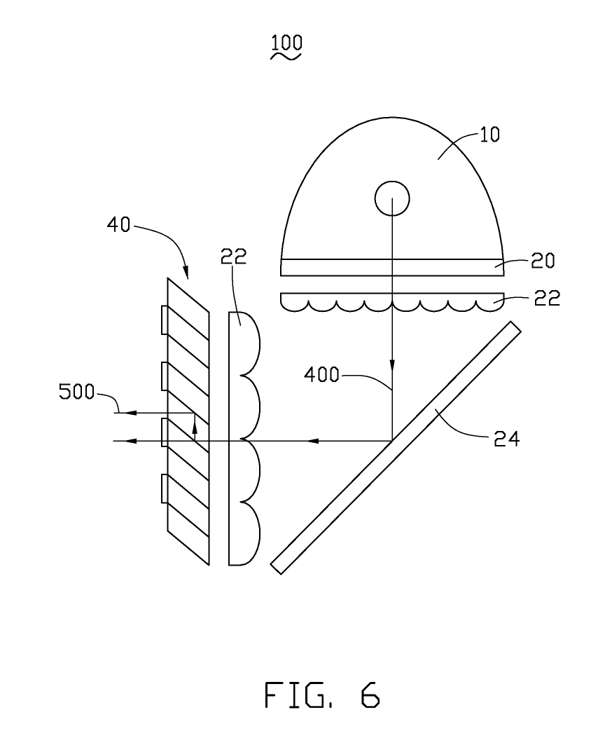

Referring to FIG. 6, a projector 100 using the PCD 40 of FIG. 1 is shown. The projector 100 includes a light source 10, an ultraviolet-infrared (UV-IR) filter 20 and two micro mirror arrays 22, a reflector 24, and the PCD 40. The PCD 40 could instead be any one of the PCDs described in the second to fourth present embodiments.

Light 400 emitted from the light source 10 goes though the UV-IR filter 20, one micro mirror array 22, and then reflected by the reflector 24 towards another micro mirror array 22, and is finally incident upon the PCD 40. The PCD 40 converts the light 400 into a single-polarized light 500, e.g., an s-polarized light for the projector 100.

Since the PCD 40 is used in the projector 100, an incident light of the light source 10 can be satisfactorily aligned with the PBSLs.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A polarization conversion device for converting a non-polarized light into a single-polarized light, comprising:
a prism substrate having a first positioning surface and an opposite second positioning surface parallel to the first positioning surface, the first and second positioning surfaces being configured for coming into contact with a positioning member, the prism substrate comprising a plurality of parallelogram prisms arranged between the first and second positioning surfaces, and a plurality of polarization beam splitting layers in parallel with the first and second surfaces, the polarization beam splitting layers and the parallelogram prisms being arranged in an alternate fashion, each of the plurality of polarization beam splitting layers being sandwiched between two adjacent parallelogram prisms.

2. The polarization conversion device as claimed in claim 1, further comprising a plurality of spaced half-wave plates arranged on a light emitting surface of the prism substrate.

3. A polarization conversion device for converting a non-polarized light into a single-polarized light, comprising:
a prism substrate having a first positioning surface and an opposite second positioning surface, the first and second positioning surfaces being configured for coming into contact with a positioning member, the prism substrate comprising a plurality of first parallelogram prisms and a plurality of second parallelogram prisms arranged between the first and second positioning surfaces, a plurality of first polarization beam splitting layers in parallel with the first positioning surface, and a plurality of second polarization beam splitting layers in parallel with the second positioning surface, the first polarization beam splitting layers and the first parallelogram prisms being arranged in an alternate fashion, each of the plurality of the first polarization beam splitting layers being sandwiched between two adjacent first parallelogram prisms, the second polarization beam splitting layers and the second parallelogram prisms being arranged in an alternate fashion, each of the plurality of second polarization beam splitting layers being sandwiched between two adjacent second parallelogram prisms.

4. The polarization conversion device as claimed in claim 3, further comprising a plurality of spaced half-wave plates arranged on a light emitting surface of the prism substrate.

5. The polarization conversion device as claimed in claim 3, wherein the prism substrate comprises a first sub prism substrate including the first polarization beam splitting layers and the first parallelogram prisms and a second sub prism substrate including the second polarization beam splitting layers and the second parallelogram prisms; the first and second sub prism substrate are positioned axisymmetrically about a central axis of the prism substrate.

6. The polarization conversion device as claimed in claim 5, wherein the first sub prism substrate comprises a first triangular prism; and an extra first polarization beam splitting layer formed between and the first parallelogram prism and the adjacent first triangular prism.

7. The polarization conversion device as claimed in claim 6, wherein the second sub prism substrate comprises a second triangular prism; and an extra second polarization beam splitting layer formed between the second parallelogram prism and the adjacent second triangular prism.

8. The polarization conversion device as claimed in claim 5, wherein the first sub prism substrate comprises a first trapezoid prism; and an extra first polarization beam splitting layer formed between the first trapezoid prism and the adjacent first parallelogram prism.

9. The polarization conversion device as claimed in claim 8, wherein the second sub prism substrate comprises a second trapezoid prism; and an extra second polarization beam splitting layer formed between the second trapezoid prism and the adjacent second parallelogram prism; and the first trapezoid prism and the second trapezoid prism are glued together.

10. The polarization conversion device as claimed in claim 5, further comprising a triangular prism positioned between the first sub prism substrate and the second sub prism substrate; a length of the triangular prism is smaller than that of the first sub prism substrate and that of the second sub prism substrate, and the first and second sub prism substrates are positioned axisymmetrically about a central axis of the triangular prism.
